(19) United States
(12) Patent Application Publication
(10) Pub. No.: US 2026/0368263 A1
(43) Pub. Date: Nov. 19, 2026

(54) INFORMATION DISCLOSURE STATEMENT GENERATION FOR ARTIFICIAL INTELLIGENCE (AI)-USED SHADOW PRIOR ART

(71) Applicant: Dorian Cartwright, San Jose, CA (US)

(72) Inventor: Dorian Cartwright, San Jose, CA (US)

(21) Appl. No.: 19/673,324

(22) Filed: May 11, 2026

(51) Int. Cl. G06F 16/93; G06F 40/103; G06F 40/174; G06Q 50/18

(52) U.S. Cl. CPC G06F 16/93; G06F 40/103; G06F 40/174; G06Q 50/184; G06F 2216/11

(57) ABSTRACT

An Information Disclosure Statement (IDS) is generated during artificial intelligence assisted drafting of a patent document. Patent matter input is received, and an artificial intelligence model generates content for a patent document, such as a patent application, claim amendment, or Office Action response. During generation of the patent document, references associated with the patent matter are identified and classified as visible references or shadow prior art references. A visible reference is displayed to a user in a manner permitting practitioner review for a possible IDS filing according to a duty of disclosure during patent prosecution. A shadow prior art reference is invisibly used by the artificial intelligence model during hidden inferencing without being displayed to the user in a manner permitting practitioner review. At least one shadow prior art reference is classified for IDS treatment, and an IDS is generated including bibliographic information for references selected based on the classification. Reference-use information may be presented to the user to assist review of shadow prior art before filing.

### FIELD OF THE INVENTION

The present disclosure generally relates to computer systems and artificial intelligence (AI) and, more specifically, to automatically generating an Information Disclosure Statement based on prior art references that are used by an artificial intelligence system during generation of patent documents.

### BACKGROUND

Patent practitioners have a duty to disclose information material to patentability to the United States Patent and Trademark Office and other patent offices. In conventional patent practice, an Information Disclosure Statement is prepared from references known to, reviewed by, or otherwise identified to the practitioner.

Artificial intelligence systems are increasingly used to assist with drafting patent documents. Such systems may generate patent applications, claim sets, specifications, abstracts, amendments, Office Action responses, appeal briefs, continuation claims, patentability analyses, prior art summaries, and related prosecution documents.

Some artificial intelligence systems perform visible prior art searches. In such workflows, a user submits a prior art query and receives a list of related patent references, non-patent literature, or other references in a visible user interface response. Because the references are displayed to the practitioner, the practitioner has an opportunity to review the references and decide whether to include one or more of them in an Information Disclosure Statement.

A different and more significant disclosure gap arises when an artificial intelligence system internally retrieves, embeds, summarizes, ranks, parses, or otherwise processes prior art references during hidden inferencing without displaying those references to the practitioner. In such circumstances, the artificial intelligence system may use an undisplayed reference to influence claim language, specification text, amendment language, or Office Action response arguments, while the practitioner is never presented with the reference and therefore has no practical opportunity to decide whether to disclose the reference in an IDS.

This hidden-use scenario is distinct from a visible prior art search result. When a prior art query returns several related patent references in a visible response, the user may elect whether to disclose those references. By contrast, when a reference is invisibly used by an artificial intelligence model during hidden retrieval, context assembly, embedding, summarization, ranking, or generation, the reference may affect the generated patent document without appearing in any visible result list, report, or user interface.

Existing patent drafting and prosecution systems do not adequately identify prior art references that are invisibly used by artificial intelligence inferencing. Nor do such systems automatically include or route such hidden AI-used references for IDS consideration. As a result, a patent practitioner may receive AI-generated patent content without knowing that the artificial intelligence system relied on prior art references that were never displayed for practitioner review.

Accordingly, there is a need for a robust IDS generation system that identifies prior art references invisibly used by artificial intelligence systems during patent document generation, distinguishes those references from visible references already available for practitioner review, evaluates such references for IDS inclusion or practitioner review, and generates an Information Disclosure Statement that accounts for hidden AI-used shadow prior art.

### SUMMARY

To address these shortcomings, systems, methods, devices, and non-transitory computer readable media are provided for generating an Information Disclosure Statement during artificial intelligence assisted drafting of a patent document.

In one embodiment, a system receives patent matter input associated with a patent matter and causes an artificial intelligence model to generate content for a patent document. During generation of the patent document, the system identifies references used by the artificial intelligence model. The references may include visible references displayed to the user and shadow prior art references invisibly used by the artificial intelligence model without being displayed to the user in a manner permitting practitioner review for possible IDS disclosure.

The system determines whether a reference was displayed to the user or was invisibly used by the artificial intelligence model during hidden inferencing. Invisible inferencing may include hidden retrieval, context assembly, embedding, summarization, ranking, parsing, prompt construction, claim drafting, specification drafting, amendment drafting, novelty analysis, obviousness analysis, or Office Action response generation.

The system identifies one or more shadow prior art references that were invisibly used by the artificial intelligence model and classifies those references for IDS treatment. Classification may include automatic IDS inclusion, IDS review Required, previously cited, cumulative, informational only, or IDS exclude.

The system generates an Information Disclosure Statement including bibliographic information for references selected based on the classification. In some embodiments, the IDS includes references that were visibly displayed to the practitioner, shadow prior art references invisibly used by the artificial intelligence model, or both.

In some embodiments, the system generates an IDS candidate for practitioner review before filing. The IDS candidate may identify shadow prior art references that the practitioner did not previously have an opportunity to review. The system may thereby close a disclosure gap created by hidden artificial intelligence reliance on undisplayed prior art.

In optional embodiments, the system records additional reference-use information to assist practitioner review. For example, the system may store a model-use state, relevance score, generated-content association, or other metadata indicating why a shadow prior art reference was included in an IDS candidate or routed for practitioner review. Such reference-use information may be used to show background references to the user for study, to allow user confirmation, or to assist practitioner evaluation, but such provenance or audit functionality is not required in every embodiment.

Advantageously, the disclosed system improves patent prosecution workflows by enabling IDS generation for prior art that is used by artificial intelligence inferencing but not displayed to a practitioner, thereby allowing the practitioner to evaluate or disclose references that would otherwise remain hidden.

### BRIEF DESCRIPTION OF FIGURES

In the following drawings, like reference numbers are used to refer to like elements. Although the following figures depict various examples of the invention, the invention is not limited to the examples depicted in the figures.

FIG. 1 is a block diagram illustrating an IDS generation system for artificial intelligence used shadow prior art, according to an embodiment.

FIG. 2 is a schematic diagram illustrating composition of an IDS structure with shadow prior art references, according to an embodiment.

FIG. 3 is a block diagram illustrating a computing device suitable for implementing the systems and methods described herein, according to an embodiment.

FIG. 4 is a flow chart illustrating a method for detecting shadow prior art references used by an artificial intelligence model during hidden inferencing, according to an embodiment.

FIG. 5 is a flow chart illustrating a method for classifying shadow prior art references for IDS inclusion or practitioner review, according to an embodiment.

### DETAILED DESCRIPTION

Systems, methods, devices, and computer program products for generating an Information Disclosure Statement during artificial-intelligence-assisted drafting of a patent document.

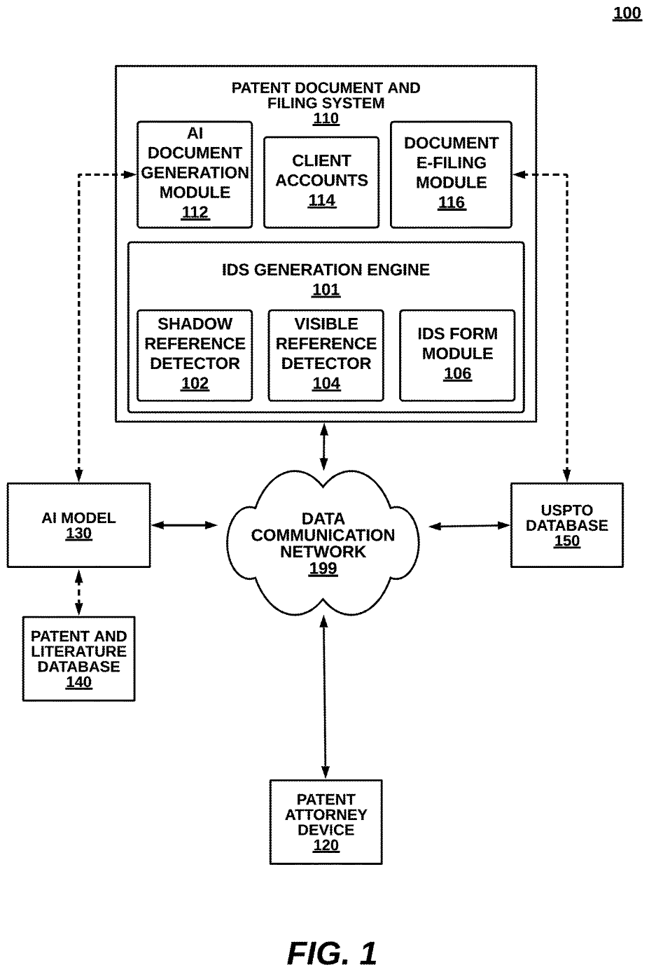

### I. System for IDS for AI-Used Shadow Prior Art (FIGS. 1-3)

Referring to FIG. 1, a block diagram illustrates an IDS generation system 100 for shadow prior art used in artificial intelligence. The IDS generation system 100 includes a patent document system 110, device (e.g., with a patent attorney user) 120, AI model 130, patent and literature database 140, and USPTO database 150. The patent document and filing system 110 further comprises AI document generation 112, client accounts 114, document e-filing 116, and IDS generation engine 101. In one embodiment, the patent document and filing system 110 manages client patent files for a law firm.

The AI document generation 112 receives patent matter input associated with a patent matter for a client in client accounts 114. The patent matter input may include an invention disclosure, draft claims, technical notes, figures, inventor comments, a prior art search request, an Office Action, examiner-cited references, proposed amendments, interview notes, continuation instructions, or other patent-related material. In one embodiment, the patent matter is received from a patent attorney, an inventor, or other user.

In another embodiment, the patent matter is received from an autonomous AI agent using an API, and results of the patent matter along with the shadow references and optional metadata, are returned to the autonomous AI agent for further processing in a workflow. For example, the patent workflow or a business workflow including patents. One business workflow is initiated by an OpenClaw AI agent that is independently executing a patent prosecution docket that includes one or more of patent applications, Office Action responses, and patent analysis.

Client accounts 114 stores information associated with the patent matter and client accounts. The information may include a docket number, application number, priority data, claim history, specification history, Office Action history, cited references, IDS history, continuation-family information, assignment status, and prosecution status. The data can be synced with the USPTO database 150, a Patent Cooperation Treat (PCT) database, or any other patent authority.

The artificial intelligence drafting engine 130 generates content for a patent document. The patent document may be a patent application, provisional application, non-provisional application, continuation application, divisional application, continuation-in-part application, claim set, specification, abstract, claim amendment, Office Action response, appeal brief, request for continued examination, IDS, or other patent prosecution document.

The IDS form module 106 identifies references associated with the artificial intelligence assisted drafting operation. The references may include patents, patent application publications, foreign patent documents, non-patent literature, standards documents, product manuals, web pages, scientific papers, code repositories, examiner-cited references, prosecution-history documents, foreign office action documents, search reports, or internal knowledge base documents.

The IDS form module 106 distinguishes between visible references and shadow prior art references. A visible reference is a reference displayed to the user in a prior art result, report, citation list, Office Action view, or user interface output such that the user is provided an opportunity to review the reference for possible IDS disclosure. A shadow prior art reference is a reference invisibly used by the artificial intelligence drafting engine 130 during hidden inferencing without being displayed to the user in a manner permitting practitioner review for possible IDS disclosure.

Hidden inferencing may include background retrieval, vector search, embedding, summarization, ranking, parsing, model context assembly, prompt construction, claim drafting, specification drafting, amendment drafting, novelty analysis, obviousness analysis, or Office Action response generation. In some embodiments, a reference is identified as shadow prior art when the reference, a chunk of the reference, a summary of the reference, an embedding of the reference, or metadata derived from the reference is used by the artificial intelligence drafting engine 130 to generate patent-document content without being shown to the practitioner.

The IDS form module 106 classifies references for IDS treatment. The classification may include IDS include, IDS review required, previously cited, cumulative, informational only, or IDS exclude. In some embodiments, the classification is based on whether a reference was visibly displayed, invisibly used by the artificial intelligence model, used to generate claim language, used to generate specification text, used to generate amendment language, used to generate an Office Action response argument, or identified as cumulative of already-cited art.

The IDS form module 106 generates an IDS or IDS candidate. The IDS may include bibliographic information for selected references. In some embodiments, the IDS form module 106 populates patent office filing fields for one or more of United States patents, United States patent application publications, foreign patent documents, and non-patent literature.

The IDS form module 106 may optionally provide a practitioner with access to shadow prior art references or summaries of shadow prior art references before filing. The IDS form module 106 may present references classified as IDS review required, allow the practitioner to mark a reference for inclusion or exclusion, and record the practitioner's review decision.

### A. Visible References and Shadow Prior Art References

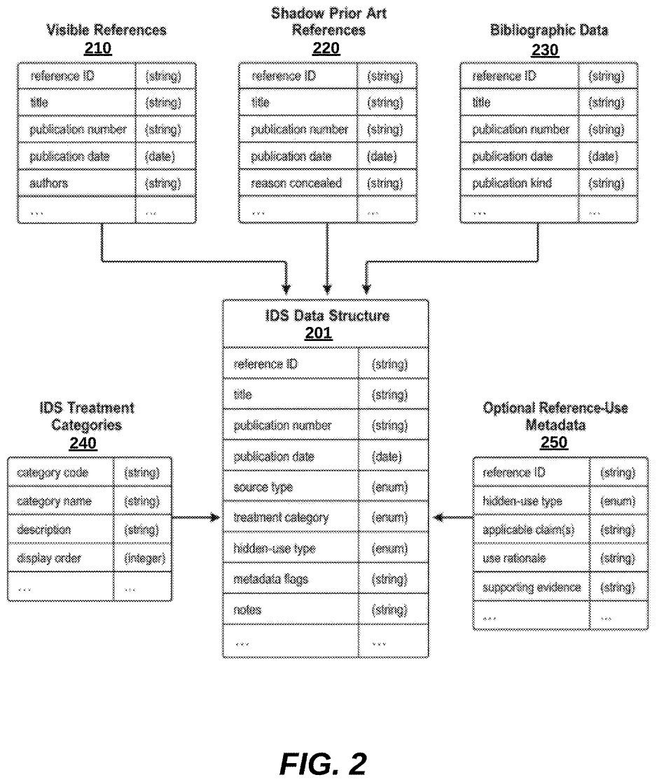

FIG. 2 illustrates separate treatment between visible references 210 and shadow prior art references 220.

A visible reference 210 is a reference displayed to the practitioner in a manner that permits practitioner review. For example, a prior art query may return a list of patent references in a visible search result. In that circumstance, the practitioner can review the references and decide whether to disclose them in an IDS. Such visible references do not create the same disclosure gap because the practitioner has an opportunity to consider them.

A shadow prior art reference 220 is a reference used by an artificial intelligence model during hidden inferencing without being displayed to the practitioner. For example, an artificial intelligence model may retrieve fifty references in a background search, use ten of the references to generate patent claim language or an Office Action response argument, and display only two references to the practitioner. The two displayed references may be selected as the most relevant, be used as an example, be first used, be randomly selected, or any appropriate algorithm. The remaining used references may be shadow prior art references if they influenced generated patent content without being displayed in a manner permitting practitioner review.

In one embodiment, the IDS generation system 100 identifies a shadow prior art reference 220 when a hidden reference is used by the AI document generation module 112 to generate or modify a claim limitation. In another embodiment, the system identifies a shadow prior art reference 220 when a hidden reference is used to draft a specification paragraph. In another embodiment, the system identifies a shadow prior art reference 220 when a hidden reference is used to generate an Office Action response argument distinguishing examiner cited prior art.

A reference may change from a shadow prior art reference to a visible reference if the system later displays the reference to the practitioner. In some embodiments, the system preserves the earlier shadow-use state to indicate that the artificial intelligence model used the reference before the practitioner was given an opportunity to review it. This may be useful for determining whether the reference should be included in an IDS candidate or routed for practitioner review.

### B. Use Cases

In one example, the practitioner enters an invention disclosure. The AI document generation module 112 generates claims, a specification, and an abstract. During generation, the AI document generation module 112 invisibly uses several references retrieved through a background retrieval process.

The shadow reference detector 102 identifies references that were used by the AI document generation module 112 but not displayed to the practitioner. The IDS form module 106 classifies the references for IDS inclusion or practitioner review. The IDS form module 106 generates an IDS candidate including bibliographic data for selected references 230.

In another example, a practitioner uses the system to draft an Office Action response. The practitioner uploads an Office Action identifying examiner cited references. The artificial intelligence drafting engine 130 generates proposed claim amendments and arguments distinguishing the cited references.

During generation, the AI document generation module 112 may retrieve and use additional references in the background. Such references may include related patents, prosecution history documents, technical articles, or foreign office action materials. If these references are not displayed to the practitioner but are used to generate amendment language or response arguments, the shadow reference detector 102 identifies them as shadow prior art references.

The IDS form module 106 classifies and routes the shadow prior art references for IDS inclusion or practitioner review. The IDS form module 106 generates an IDS, a supplemental IDS candidate, or custom review package. In this manner, the practitioner is given an opportunity to evaluate references that the artificial intelligence model used during Office Action response drafting but did not display.

### C. Computing Environment

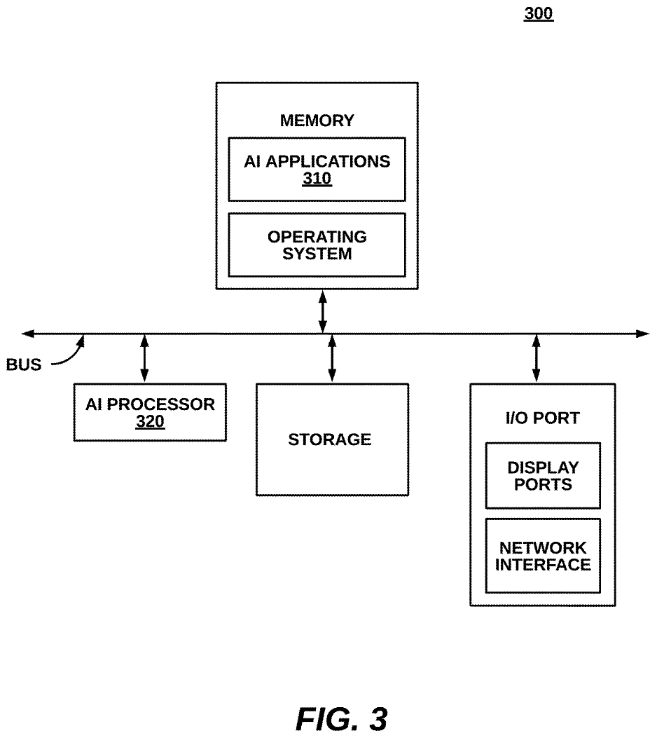

FIG. 3 is a block diagram illustrating an example computing environment 300 that may be used to implement one or more components of the IDS generation systems described herein, according to an embodiment. The computing environment 300 may correspond to, or may be included within, the patent document and filing system 110, the patent attorney device 120, the AI model 130, the patent and literature database 140, a data center hosting one or more of the foregoing components, or another computing device or distributed computing environment used for artificial intelligence assisted patent document drafting and IDS generation.

The computing environment 300 may include one or more processors, memories, storage devices, communication interfaces, input/output interfaces, display ports, network interfaces, operating systems, software modules, or other computing components coupled directly or indirectly by one or more buses or communication pathways. Components shown as separate blocks may be integrated into a single device, distributed across multiple devices, implemented as virtualized components, or provided by a cloud-hosted service.

In some embodiments, the computing environment 300 stores or executes AI applications 310. The AI applications 310 may include software instructions, services, agents, interfaces, or modules configured to perform one or more of patent matter intake, artificial intelligence assisted patent document generation, reference detection, visible reference detection, shadow reference detection, IDS classification, bibliographic extraction, IDS form generation, document e-filing, practitioner review, docketing-system integration, patent-office database access, or patent and literature database access.

In some embodiments, the AI applications 310 cause the computing environment 300 to receive patent matter input, generate or request generation of patent document content, identify references used or retrieved during artificial intelligence assisted drafting, determine whether a reference was displayed to a practitioner or was invisibly used by artificial intelligence inferencing, classify one or more shadow prior art references for IDS treatment, and generate an Information Disclosure Statement or IDS candidate.

The AI processor 320 may comprise one or more of a central processing unit, graphics processing unit, tensor processing unit, neural processing unit, digital signal processor, application-specific integrated circuit, field-programmable gate array, system-on-chip, accelerator array, secure processor, or other processing circuitry configured to execute artificial intelligence workloads or supporting control logic. In some embodiments, the AI processor 320 executes local artificial intelligence inference for patent document drafting. In other embodiments, the AI processor 320 executes supporting functionality for a remote artificial intelligence model, including reference detection, shadow reference detection, IDS classification, bibliographic extraction, or practitioner review workflows.

In one embodiment, the computing environment 300 is implemented locally at the patent attorney device 120. In another embodiment, the computing environment 300 is implemented remotely at a data center that hosts the AI model 130 or other cloud-based artificial intelligence services. In another embodiment, the computing environment 300 is implemented as part of the patent document and filing system 110. In another embodiment, the computing environment 300 is implemented as part of the patent and literature database 140. In still another embodiment, functions of the computing environment 300 are distributed among the patent attorney device 120, patent document and filing system 110, AI model 130, patent and literature database 140, and one or more data centers.

Although FIG. 3 illustrates a single computing environment 300, the disclosed functions may be distributed among multiple computing environments. For example, the patent attorney device 120 may provide a user interface, the patent document and filing system 110 may manage patent matter records and IDS generation, the AI model 130 may perform artificial intelligence assisted drafting, the patent and literature database 140 may provide reference retrieval, and a data center may host one or more of the foregoing components. Any suitable distribution of hardware, software, or networked components may be used without departing from the disclosed IDS generation techniques.

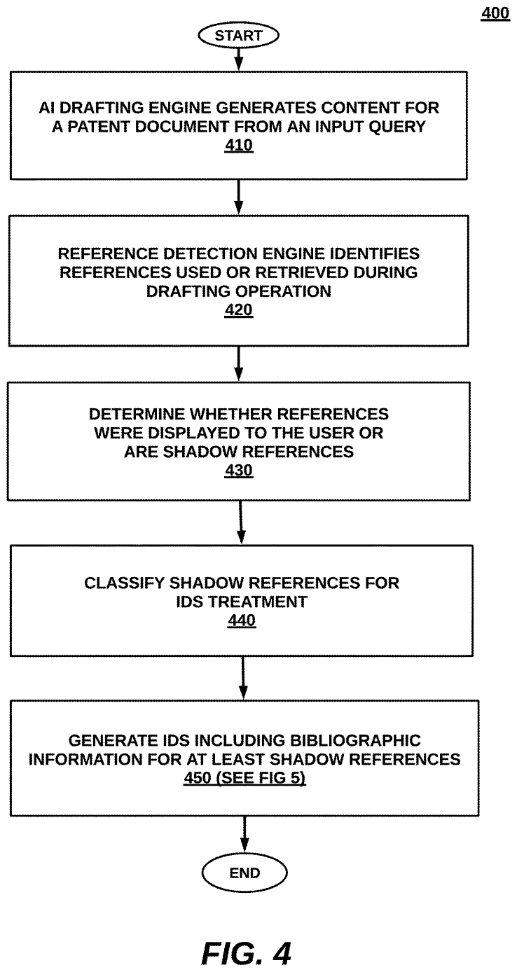

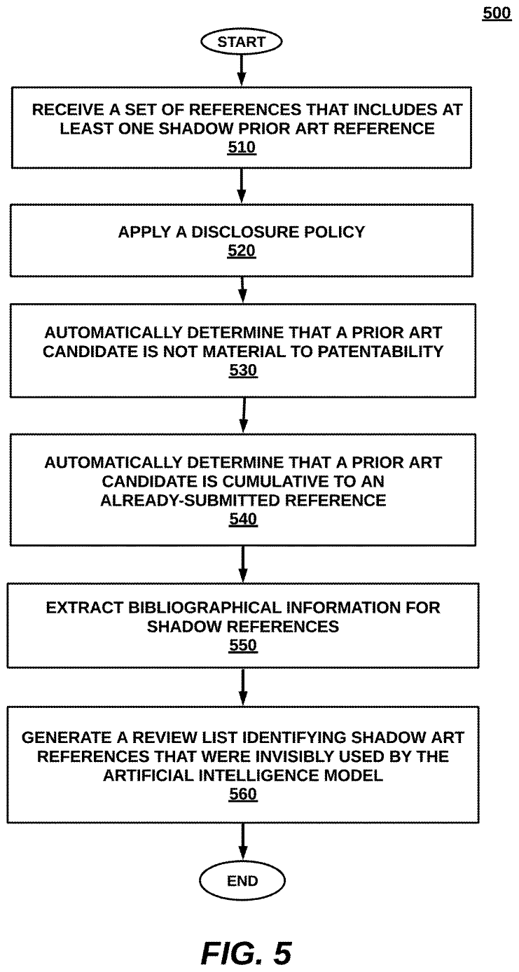

### II. Methods for IDS for AI-Used Shadow Prior Art (FIGS. 4-5)

The below-mentioned methods are just examples in which steps can be performed in different orders and functions can be grouped differently. Many other variations of the described methods and steps are possible.

### A. IDS Generation During Patent Document Drafting

FIG. 4 illustrates a method 400 for generating an Information Disclosure Statement during artificial-intelligence-assisted drafting of a patent document.

At step 410, the artificial intelligence drafting engine 130 generates content for a patent document using patent matter input. The patent matter input may relate to a patent application, claim set, amendment, Office Action response, appeal brief, continuation application, divisional application, continuation-in-part application, or other patent prosecution document.

At step 420, the reference detection engine 140 identifies references used or retrieved during the drafting operation.

At step 430, the shadow reference detector 102 determines whether each reference was displayed to the user in a manner permitting practitioner review or was invisibly used by the AI document generation module 112 during hidden inferencing. More specifically, although the AI model 130 may be executed locally it is preferably remotely executed at a data center. The system identifies at least one shadow prior art reference invisibly used by the artificial intelligence drafting engine 130 without being displayed to the practitioner. In one embodiment, an auditing system sends the shadow references remotely from the AI model 130 to the shadow reference detector 102 (via the AI document generation module 112). In another embodiment, local edge inferencing can be directly queried for, or automatically provide, shadow references.

At step 440, the IDS form module 106 classifies the shadow prior art reference for IDS treatment. In some embodiments, the classification is based on a duty of disclosure policy, practitioner settings, matter settings, relevance metrics, or the type of generated content influenced by the reference. In some cases, the prior art reference is checked for materiality and cumulative standards.

At step 450, the IDS form module 106 generates an IDS or IDS candidate including bibliographic information for one or more selected references. The system optionally presents the IDS candidate to the practitioner for review before filing. The system can file electronically, or the patent attorney may choose to transmit via mail or fax.

### B. IDS Classification and Generation

FIG. 5 illustrates a method 500 for IDS classification and generation.

At step 510, the system receives a set of references that includes at least one shadow prior art reference.

At step 520, the IDS form module 106 applies a disclosure policy. The disclosure policy may be configured to include all shadow prior art references, route all shadow prior art references for practitioner review, include shadow prior art references that affected generated claims or arguments, exclude references classified as cumulative, or apply other matter specific or practitioner specific rules.

At step 530, the IDS classification engine automatically determines that a potential prior art reference is not material to patentability. For example, the IDS classification engine may determine that a shadow prior art reference was retrieved or processed by the artificial intelligence model but did not teach or suggest any limitation of a pending claim, did not contradict a position taken by the applicant, did not affect a generated amendment or Office Action response argument, and did not provide information beyond references already known or cited in the patent matter. In response, the IDS classification engine may classify the reference as IDS exclude, informational only, or practitioner review optional rather than automatically including the reference in the IDS.

At step 540, the IDS classification engine automatically determines that a potential prior art reference is cumulative of one or more references already submitted, cited, or selected for inclusion in an Information Disclosure Statement. The cumulative determination may be based on overlap between claim limitations disclosed by the potential prior art reference and claim limitations disclosed by previously cited references, semantic similarity between technical teachings, shared family membership, common priority data, duplicate publication data, overlapping figures or specification text, overlapping assignee or inventor data, or a comparison of generated claim charts. When the IDS classification engine determines that the potential prior art reference is cumulative, the system may classify the reference as cumulative, previously cited, informational only, or review-required without automatically including the reference in the Information Disclosure Statement.

In some embodiments, the IDS classification engine generates a reason code for a non-material or cumulative classification. Example reason codes include: duplicate reference, same patent family, previously cited counterpart, no mapped claim limitation, no contradiction of applicant argument, cumulative teaching, low relevance score, below materiality threshold, or only linguistic influence. The reason code may be stored with the reference classification and optionally displayed to the practitioner before filing.

In some embodiments, the system applies different treatment to a shadow prior art reference depending on whether the reference was substantively used by the artificial intelligence model or merely retrieved during a background search. A reference that was merely retrieved, embedded, or ranked but did not influence claim language, specification text, amendment language, or an Office Action response argument may be classified as non-material, informational only, or excluded. A reference that influenced generated patent document content may be routed for IDS review or inclusion unless the IDS classification engine determines that the reference is cumulative or otherwise not material.

At step 550, the system extracts bibliographic information for references selected for inclusion or review. Bibliographic information may include patent number, publication number, title, publication date, inventor, assignee, author, journal, publisher, URL, document date, country, kind code, or document type.

At step 560, the system generates a review list identifying shadow prior art references that were invisibly used by the artificial intelligence model. These references may be automatically included in an IDS. In another embodiment, the review list may allow the practitioner to study background references that the practitioner did not previously have an opportunity to review.

The system optionally records practitioner review decisions. A practitioner may mark a reference as include, exclude, previously cited, cumulative, or further review required.

### D. Optional Reference-Use and Provenance Embodiments

In some embodiments, the IDS generation system 100 stores additional reference use information to assist the practitioner. Such information may include a model use state, relevance score, contribution score, generated-content association, or reason code for IDS classification.

These optional reference use features are not required for the main IDS generation invention. The techniques may be practiced by identifying shadow prior art references invisibly used by artificial intelligence inferencing and generating an IDS or IDS candidate that includes or routes such references for review.

Optional reference-use information may be useful to show the user background references for study. For example, the system may display a shadow prior art reference and indicate that the reference was used during claim drafting, specification drafting, amendment drafting, or Office Action response drafting. The practitioner may then study the reference and decide whether to include it in an IDS.

In some embodiments, optional reference-use information may identify a portion of a patent document associated with a shadow prior art reference. The portion may include a claim limitation, claim term, specification paragraph, amendment, Office Action response argument, prior art distinction, rejection identifier, or generated text span.

In some embodiments, optional reference-use information may be stored in a review table, audit log, matter file, docketing system, or practitioner dashboard. Such records may assist in explaining why a shadow prior art reference was routed for IDS review, but the IDS generation system does not require a complete provenance audit of the artificial intelligence process.

### III. Generalities of the Disclosure

This description of the invention has been presented for the purposes of illustration and description. It is not intended to be exhaustive or to limit the invention to the precise form described, and one of ordinary skill in the art will recognize many modifications and variations are possible in light of the teaching above. The embodiments were chosen and described in order to best explain the principles of the invention and its practical applications, in a concise manner. This description will enable others skilled in the art to best utilize and practice the invention in various embodiments and with various modifications as are suited to a particular use.

The scope of the invention is defined by the following claims.

I claim:

1. A computer-implemented method for generating an Information Disclosure Statement during artificial intelligence assisted drafting of a patent document, the method comprising:
receiving, by one or more processors through a user interface, patent matter input associated with a patent matter;
executing, by an artificial intelligence model, a drafting operation based on the patent-matter input to generate content for the patent document;
identifying, during the drafting operation, a plurality of references associated with the patent matter input;
determining, for each reference of the plurality of references, whether the reference is:
(i) a visible reference displayed to a user in a prior art result, report, or user-interface output such that the user is provided an opportunity to review the visible reference for possible inclusion in the Information Disclosure Statement; or
(ii) a shadow prior art reference invisibly used by the artificial intelligence model during hidden inferencing without being displayed to the user in a manner permitting practitioner review for possible inclusion in the Information Disclosure Statement;
classifying, by an IDS classification engine, at least one shadow prior art reference for IDS treatment based at least in part on invisible use of the at least one shadow prior art reference by the artificial intelligence model; and
generating the Information Disclosure Statement comprising bibliographic information for one or more references selected based on the classifying.

2. The method of claim 1, wherein the patent document comprises a patent application.

3. The method of claim 1, wherein the patent document comprises an Office Action response.

4. The method of claim 1, wherein the patent document comprises at least one of a patent claim set, a patent specification, a claim amendment, remarks responsive to an examiner rejection, an appeal brief, a pre-appeal brief request, a request for continued examination, a continuation application, a divisional application, a continuation-in-part application, or an IDS-related document.

5. The method of claim 1, wherein hidden inferencing comprises at least one of hidden retrieval, vector search, embedding, parsing, summarization, ranking, model-context assembly, prompt construction, claim drafting, specification drafting, amendment drafting, novelty analysis, obviousness analysis, or Office Action response generation.

6. The method of claim 1, wherein generating the Information Disclosure Statement comprises generating an IDS candidate for practitioner review before filing.

7. The method of claim 1, wherein generating the Information Disclosure Statement comprises populating patent-office filing fields with bibliographic information for at least one shadow prior art reference.

8. The method of claim 1, wherein classifying the at least one shadow prior art reference comprises assigning the at least one shadow prior art reference to at least one category comprising IDS-include, IDS-review-required, previously-cited, cumulative, informational-only, or IDS-exclude.

9. The method of claim 1, wherein determining that a reference is a shadow prior art reference comprises determining that the reference, a portion of the reference, a summary of the reference, an embedding of the reference, or metadata derived from the reference was used by the artificial intelligence model without being displayed to the user.

10. The method of claim 1, wherein the at least one shadow prior art reference was used by the artificial intelligence model to generate claim language, specification text, amendment language, or an Office Action response argument.

11. The method of claim 1, further comprising presenting the at least one shadow prior art reference to the user for review before filing the Information Disclosure Statement.

12. The method of claim 1, further comprising deduplicating references appearing as both visible references and shadow prior art references while preserving an indication that a respective reference was invisibly used by the artificial intelligence model before user review.

13. The method of claim 1, wherein classifying the at least one shadow prior art reference comprises applying a configurable duty of disclosure policy to determine whether the at least one shadow prior art reference should be included in the Information Disclosure Statement or routed for practitioner review.

14. The method of claim 1, wherein the Information Disclosure Statement is generated in a format suitable for filing with a patent office.

15. The method of claim 1, wherein identifying the plurality of references comprises identifying at least one patent document, published patent application, foreign patent document, non-patent literature reference, scientific paper, product manual, standards document, web page, prosecution-history document, search report, or foreign-office-action document.

16. The method of claim 1, further comprising storing reference-use information for the at least one shadow prior art reference, the reference-use information indicating a type of hidden use by the artificial intelligence model.

17. The method of claim 16, wherein the type of hidden use indicates whether the at least one shadow prior art reference was used for claim drafting, specification drafting, amendment drafting, Office Action response drafting, novelty analysis, obviousness analysis, prior art distinction, or IDS classification.

18. The method of claim 16, further comprising displaying the reference-use information to the user to assist user review of the at least one shadow prior art reference.

19. A system for artificial-intelligence-assisted Information Disclosure Statement generation for shadow prior art, the system comprising:
one or more processors; and
memory storing instructions that, when executed by the one or more processors, cause the system to:
receive patent-matter input associated with a patent matter;
generate, using an artificial intelligence model, content for a patent document;
identify references used or retrieved during generation of the content;
determine whether a respective reference is a visible reference displayed to a user for possible IDS review or a shadow prior art reference invisibly used by the artificial intelligence model without being displayed to the user in a manner permitting practitioner review for IDS disclosure;
classify at least one shadow prior art reference for IDS treatment; and
generate an Information Disclosure Statement based on the classification.

20. A computer-implemented method for generating a reference review output during artificial-intelligence-assisted patent document generation, the method comprising:
identifying, during generation of a patent document by an artificial intelligence model, a reference invisibly used by the artificial intelligence model without being displayed to a user;
storing reference-use information indicating that the reference was invisibly used by the artificial intelligence model; and
generating a reference review output configured to present the reference to the user for study, review, or disclosure consideration.
